(19) United States
(12) Patent Application Publication
(10) Pub. No.: US 2007/0212474 A1
(43) Pub. Date: Sep. 13, 2007

(54) Frozen cat food

(76) Inventor: Stephanie Nadeau, Kennebunkport, ME (US)

Correspondence Address: BOHAN, MATHERS & ASSOCIATES, LLC, PO BOX 17707, PORTLAND, ME, 04112-8707, US

(21) Appl. No.: 11/369,672

(22) Filed: Mar. 7, 2006

(51) Int. Cl. A23L 1/325

(52) U.S. Cl. 426/643

(57) ABSTRACT

Frozen cat food that contains only whole food ingredients. The whole food ingredients include fresh human-grade meat and/or poultry food products, mollusk, vegetables and fruit, and additional ingredients such as wheat germ, wheat germ oil, lecithin, and rice bran. The food ingredients are raw, with the exception of mollusk, which may be cooked. The cat food is made of only human-grade food products and contains no non-food additives, such as amino acid, mineral or vitamin supplements. The raw frozen cat food provides a complete and balanced diet that meets or exceeds AAFCO standards.

### BACKGROUND INFORMATION

1. Field of the Invention

The invention relates to the field of pet food. More particularly, the invention relates to cat food. More particularly yet, the invention relates to cat food that is made from whole, human-grade food, and which provides AAFCO recommended amounts of vitamins, minerals, and enzymes.

2. Description of the Prior Art

Cats are well-loved, popular house pets. Many cat owners are devoted to their cats and concerned about their health and well-being. To this end, they desire to feed their feline pets healthy and nutritious food that provides a complete and balanced diet that is particularly adapted to the nutritional needs of a cat. Some cat owners are particularly concerned that they also feed their pets food that is natural, that is, free of added minerals and supplements, chemical enhancers and preservatives, nutritionally useless fillers, etc. Many commercially available brands and types of cat food claim to be “all natural,” or to provide a “complete and balanced” diet for a cat, but nevertheless still contain ingredients that are foreign to the natural diet of a cat or are useless fillers, such as corn meal or other carbohydrates which a cat is incapable or only minimally capable of digesting and extracting nutrients from.

The cat is an “obligate carnivore,” that is, it must eat meat to sustain life or remain healthy. This fact makes it difficult, for several reasons, to maintain the health of a cat that is fed with food that contains only natural food ingredients, and does not include non-food supplements. First, the cat is unable to synthesize or produce numerous life-sustaining food chemicals, such as certain amino acids, minerals, and vitamins. It relies on an animal-based diet to obtain these chemicals from other animals, who produce or synthesize them in a form the cat can digest.

The basic nutritional needs of a cat are: protein from an animal food product; taurine, an essential amino acid; certain vitamins, minerals, enzymes and fatty acids; and water. The most difficult ingredient to provide in natural cat food in the recommended amount for a cat is the taurine. Taurine is especially important for cats in the prevention of blindness and heart disease. This amino acid is abundantly present in insects, present at much lower levels in land animals, and generally absent or present in trace amounts only in bacteria and plants. For example, the taurine content in plant foods is measured generally in the nmol range, that is, billionths of a mole, and measured generally in the micro-mole range, that is, millionths of a mole, in animal foods. Studies have shown that taurine also deteriorates when exposed to heat. Table 1 lists a number of food products and shows their taurine levels raw, baked, and boiled food. The greatest amount of taurine is available in raw food products, a lesser amount available in baked food products, and the least amount available in boiled food products.

TABLE 1
Taurine Content of Selected Foods (mg/kg, wet weight)*

| | RAW | RAW | BAKED | BAKED | BOILED | BOILED |
|---|---|---|---|---|---|---|
| ITEM | MEAN | RANGE | MEAN | RANGE | MEAN | RANGE |
| Beef Muscle | 362 | 150-472 | 133 | 96-125 | 60 | 58-63 |
| Beef Liver | 192 | 144-270 | 141 | 68-184 | 73 | 36-95 |
| Beef Kidney | 225 | 180-247 | 138 | 130-144 | 76 | 68-88 |
| Lamb Muscle | 473 | 446-510 | 257 | 220-284 | 126 | 91-184 |
| Lamb Kidney | 239 | 128-440 | 154 | 81-290 | 51 | 47-55 |
| Pork Muscle | 496 | 394-690 | 219 | 126-390 | 118 | 91-184 |
| Pork Liver | 169 | 110-228 | 85 | 70-100 | 43 | 30-54 |
| Chicken Muscle | 337 | 300-380 | 229 | 140-310 | 82 | 71-180 |
| Cod Fish | 314 | 233-396 | 294 | 260-328 | 161 | 125-198 |
| Oysters | 698 | 390-1238 | 264 | 217-308 | 89 | 59-122 |
| Clams | 2400 | 1450-3700 | 1017 | 587-1700 | 446 | 264-794 |

Taurine is, however, abundantly present in seafood, particularly in shellfish, and most particularly in mollusks (clams, snails, octopus, squid, inkfish, scallops, etc.). For example, oysters provide 698 and claims 2400 mg of taurine per kg net weight of the respective food product. Shrimp, on the other hand, has levels of taurine that are comparable with land-animal food products. Table 2 lists a wide range of animal food products and their corresponding taurine levels. The levels are given for raw food product, and again, the levels of taurine drop significantly when the food product is baked or boiled.

TABLE 2

| | Taurine content |
|---|---|
| Food | (in mg/kg) |
| Conch (Strombus gigas) | 8500 |
| Inkfish | 6720 |
| Blood Clam | 6170 |
| Shellfish | 3320 |
| Crab | 2780 |
| Prawn | 1430 |
| Sole | 2560 |
| Crucial carp | 2050 |
| Silver carp | 900 |
| Hairtail fish | 560 |
| Yellowfish | 880 |
| Octopus | 3900 |
| Cat, entire body | 2000 |
| Eel | 910 |
| Pork meat | 1180 |
| Pork heart | 2000 |
| Pork kidney | 1200 |
| Pork liver | 420 |
| Chicken breast | 260 |
| Chicken leg | 3780 |
| Quail muscle | 95-280* |
| Quail serum | 0.50-0.9* (in mg/L) |
| Tuna canned | 3320 |
| Low-fat plain yogurt | 7.8 (in mg/L) |
| Shrimp | 1150 |
| Cheetah serum | 0.8-6.3 |
| Cat serum | 6-14 |

The second reason that it is difficult to maintain the health of a cat fed with food that contains only natural food ingredients, is that the cat has difficulty digesting carbohydrates. The feline liver has normal hexokinase activity, but no glucokinase activity. In other words, it is incapable of converting the sugars in grains into glucose or other forms that it can then convert to energy. Being a carnivore, it has a tremendous ability to produce glucose from protein, but has only limited ability to convert glucose from grain into glycogen. As a result, the glucose it ingests is stored as fat. In addition, unlike with humans, protein is the stimulus for insulin release in the cat, which has developed insulin resistance as it adapted to a high protein diet. This resistance maintains blood glucose levels during periods of fasting, which is convenient for a cat in the wild, but it is not healthy for a cat that eats a diet rich in carbohydrates. (Notes from the 2003 AVMA Convention, from: www.catnutrition.org/catkins.html).

The American Association of Feed Control Officials (AAFCO) is an organization that defines terms for labeling pet food products, e.g., “meat by-products.” It also defines quantity determination for label titles, e.g., “Chicken Cat Food,” “Chicken Dinner for Cats,” “Chicken-flavored Cat Food,” sets criteria for the usage of “complete and balanced” on pet food labels, and recommends percentage or minimum/maximum amounts of various ingredients in pet foods, depending on age and activity level of the cat. Many conventional pet foods, even pet foods recommended by veterinarians and those that are advertised as food that meets AAFCO standards and provides a complete and balanced diet, are high-carbohydrate foods that are unsuitable for the cat. Such AAFCO-quality foods, particularly dry cat foods, typically contain meat by-product or meat by-product meal, grains, such as ground whole grain corn or ground brown rice, brewers rice, animal fat, corn gluten meal, meat flavor, and then a long list of non-food additives that provide the needed amino acids, vitamins, minerals, enymes, as well as flavor and aroma enhancers. A typical AAFCO-quality wet cat food that is labeled as a chicken-hearts-and-liver-in-gravy food comprises poultry broth, chicken hearts, chicken livers, turkey, wheat gluten, meat by-product, chicken liver, corn starch, soy flour, soy protein concentrate, natural and artificial flavors, salt, and then a long list of non-food additives. Many commercial cat foods contain no meat at all, but are made up completely of grain products and non-food additives that provide vitamins, minerals, amino acids, and flavor.

Many cat owners believe that good natural food is the foundation for maintaining health, for themselves, as well as for their pets, and desire a cat food that provides all the necessary ingredients to maintain a healthy cat. Such cat owners desire a cat food that contains all natural food products, that is devoid of non-food additives. Furthermore, such cat owners desire a cat food that is produced according to hygienic food standards, from high-quality food products. It is know that in the pet food industry, the ingredients used are often discarded waste products unfit for human consumption. These waste products are often diseased or decaying animal parts. Many pet owners would like to know that the ingredients used in the pet food they buy are of a quality standard deemed adequate for human consumption and have been handled and prepared under standards of hygiene that are equivalent to the standards required in the handling and processing of food for human consumption.

What is needed, therefore, is a cat food that contains ingredients that satisfy all the nutritional needs of the cat, that does not contain artificial or unnatural additives, whether in the form of vitamin and/or mineral supplements, flavor enhancers, fillers, etc. What is further needed is such a cat food that is high in animal protein and low in carbohydrates. What is yet further needed is such a cat food that is prepared according to high standards of hygiene, from food that is of a quality for human consumption.

### BRIEF SUMMARY OF THE INVENTION

The invention is a cat food that provides a healthy, nutritious, fully balanced and complete diet for a cat, and that contains only whole food, human-grade ingredients. The cat food according to the invention contains primarily ingredients from fresh animal food products, such as poultry, fish, and mollusks, and small amounts of organic land and sea vegetables, rice bran, wheat germ, certain oils extracted from whole foods, dried autolyzed yeast extracted from whole food, and water. It contains no non-food additives, such as mineral or vitamin supplements. Ideally, the ingredients are raw, that is, not processed with heat.

The cat food according to the invention is formulated and tested to meet standards set by AAFCO. The AAFCO standards require that nutritional elements necessary to maintain the health and life of a cat must be provided in the cat food within specified min-max limits. Such nutritional elements include: thiamine, taurine, zinc, iron, copper, manganese, vitamin E, vitamin D, phosphorus, methionine, magnesium, choline, and folic acid, and others.

The common ingredients for the cat food according to the invention are: clams, water, vegetables, oysters, rice bran, lecithin, wheat germ, apple, flax seed, dried autolyzed yeast, dried kelp, flax oil, wheat germ oil, and cod liver oil. Depending on the particular flavor of the cat food product, chicken with chicken heart and liver, turkey with turkey heart and liver, duck with chicken, chicken heart and duck liver, or tuna and conch with chicken heart and liver are added as the major ingredient. Each of the common ingredients provides certain vitamins, minerals, or amino acids that are necessary to achieve a complete and balanced diet for a cat, according to AAFCO standards.

The first major group of ingredients in the cat food includes marine-animal food products, such as clams and oysters, and cod liver oil and non-marine-animal liver, such as chicken liver. The clams contribute the necessary levels of taurine and iron. The minimum requirement on taurine cannot be met without the clams, unless it is provided as a non-food supplement. The necessary vitamin D level could be met by increasing the amount of cod liver oil, but that would also provide excess amount of vitamin A. Oysters provide the required amont of zinc and copper. Without adding oysters to the cat food, the required amount of zinc and copper can be met only by adding non-food supplements. Liver, be it chicken liver, turkey liver, or duck liver, contributes necessary amounts of iron and folic acid. Without the liver, these vitamins would have to be provided by non-food additives. The cod liver oil also contributes vitamin D, phosphorus, methionine, and magnesium. The required vitamin D level could be obtained by increasing the proportion of oyster in the food, but the oysters do not provide the phosphorus, methionine, and magnesium that the cod liver oil does.

The second group includes wheat germ, wheat germ oil, and rice bran, which provide the necessary amount of manganese, magnesium, and vitamin E. Many cat foods include high amounts of carbohydrates, particularly grain flours, such as wheat, corn and soy flour products. These ingredients are typically listed on the pet food label as wheat gluten, corn meal, soy flour, etc. Such grain flour products are not digestable by cats and are merely non-nutritional fillers that bulk up the food and add calories, without contributing nutritional value. The grain products used in the cat food are limited to small amounts of wheat germ, wheat germ oil, and rice bran. The germ and bran the parts of grain that are dense with nutritional elements and that provide the life-sustaining elements of manganese, magnesium, and phosphorus in amounts that are sufficient to maintain a healthy cat diet. These parts of the wheat and rice grains provide vitamin E, and manganese and magnesium in amounts that are not found in other natural food ingredients. Manganese, magnesium, and phosphorus are also found in animal tissue, but not in sufficient quantity. They are abundantly present in grains, seeds, or nuts, whereby rice bran contains a much greater amount than other brans. It is possible to replace the rice bran with oat bran, for example, but a much greater amount would have to be added to the pet food and that would make the food less desirable in terms of flavor to the cat. The carbohydrate-rich part of the grain, the inner starchy endosperm from which cereal grain flours or meals are milled and gluten extracted, is indigestible for cats and is not included as an ingredient. Rice bran is preferred over other brans, because is much richer in iron than other brans. It has four times the iron found in oat bran and twice the iron found in wheat bran. It has twice as much phosphorus as wheat bran, 50 to 100% more potassium than wheat or oat bran, twice as much zinc as oat bran, twice as much magnesium as oat bran or wheat bran, and twice the thiamine found in oat and wheat.

The third group of ingredients includes dried autolyzed yeast, which provides the necessary amount of thiamine, and lecithin, which provides the necessary amount of choline. The lecithin is obtained from soy and the yeast from extracts of fermented cane or beet molasses.

The cat food according to the invention contains between 80 and 90% animal food products and between 10 and 20% non-animal food product. Of this animal food product, between 13 and 17% is made up of clams and another 1.6% made up of oysters. The rest is made up of whole chicken or whole duck, chicken legs, tuna, conch, chicken liver, dried chicken liver, and chicken hearts. The 10-20% non-animal food products includes vegetable, fruit, dried kelp, and various food oils, yeast, bran, germ, lecithin, and flax seed. Fresh or dried vegetables and fruit make up 50% of this non-animal food products and include fresh and/or dried spinach, mushrooms, apple, broccoli, peas, beets, carrot and asparagus. Wheat germ, rice bran, dried yeast, lecithin, flax seed, dried kelp, wheat germ oil, flax seed oil, and cod liver oil make up the remaining 50% of this non-animal food product.

The cat food is processed in a facility certified by the USDA for processing and manufacturing food for human consumption. All raw fresh ingredients are handled and stored at 30 to 40 degrees Fahrenheit. The cat food is processed in small batches, quickly packed, and blast frozen in 100 gram containers at minus 10 degrees Fahrenheit. The cat food is then stored and transported according to USDA and HACCP standards and requirements.

### BRIEF DESCRIPTION OF THE DRAWINGS

FIG. 1 is a table showing the various recipes of cat food according to the invention and the corresponding guaranteed crude analysis.

FIG. 2 shows the product composition of raw turkey cat food according to the invention.

FIG. 3 shows the product composition of raw chicken cat food according to the invention.

FIG. 4 is a nutrient list for the raw frozen chicken, duck, tuna and turkey cat food recipes according to the invention, listing the major ingredients necessary to provide a healthy diet for cats in the growth and reproduction and maintenance life stages.

### DETAILED DESCRIPTION OF THE INVENTION

The present invention will now be described more fully in detail. Recipes represent various embodiments of the invention. This invention should not, however, be construed as limited to the embodiments set forth herein; rather, they are provided so that this disclosure will be complete and will fully convey the scope of the invention to those skilled in the art.

A first embodiment of a pet food according to the invention is a raw frozen cat food that contains only raw, whole food, human-grade ingredients, and that provides all the nutritional elements necessary to achieve and maintain the nutritional basis for a healthy feline. The raw frozen cat food according to the invention contains primarily ingredients from fresh animal food products, such as poultry, fish, and mollusks, and small amounts of organic land and sea vegetables, rice bran, wheat germ, certain oils extracted from whole foods, dried autolyzed yeast extracted from whole food, and water. It contains no non-food additives, such as amino acid, mineral or vitamin supplements. Further, it contains no grain flour and no gluten. The term “grain flour” as used herein includes grain meal, as well as other ground, milled, rolled, cut, or chopped food products that include the endosperm of a cereal grain.

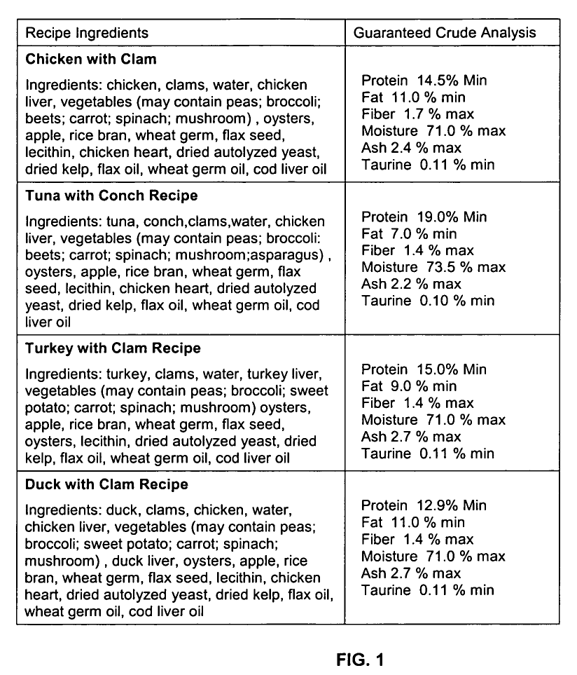

FIG. 1 lists all the ingredients and the guaranteed crude analysis for four recipes or embodiments of the raw frozen cat food according to the invention. The recipes include chicken with clam; tuna with conch; turkey with clam; and duck with clam. A study of the lists of ingredients reveals that clams, vegetables, oysters, rice bran, lecithin, wheat germ, apple, flax seed, dried autolyzed yeast, dried kelp, flax oil, wheat germ oil, and cold liver oil are common ingredients in all four recipes. Chicken heart or turkey heart is included in each recipe. The variable ingredients are the main ingredients chicken, tuna and conch, turkey, and duck and chicken. The ingredients are listed in descending order of content by weight. Thus, it can be seen that animal flesh, be it poultry, fish, or mollusk, is the main ingredient in each recipe. None of the recipes includes any non-food additive. All of the recipes provide adequate amounts of protein, fat, fiber, and taurine, with low amounts of ash. None of the foods included in the recipes is there simply to provide bulk or texture. Each food provides at least one required nutrient. Dried autolyzed yeast, for example, is used instead of other yeasts because it is much higher in thiamine than other yeasts. Apple, broccoli, and peas provide folic acid and soluble fiber. Mushrooms are a non-animal source of vitamin D and are used to boost the level of vitamin D provided by other ingredients.

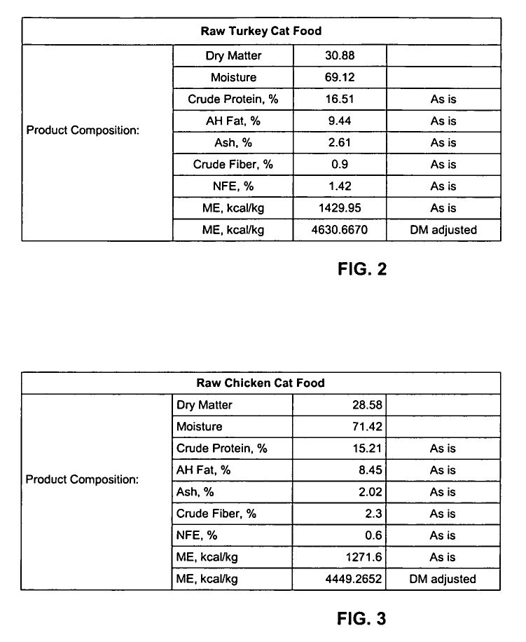

Four recipes or embodiments mentioned above were tested by Pet Food & Ingredient Technology, Inc. of Topeka, Kans., an independent research institute. FIGS. 2 and 3 show the product composition of two of the four recipes, as an illustration of various compositions of the raw frozen cat food according to the invention. In the raw turkey recipe, the water content is 69.12% and the dry matter 30.88%. The 30.88% of dry matter comprises 16.51% crude protein, 9.44% fat (acid hydrolyzed fat), 2.61% ash, 0.9% crude fiber, and 1.42% nitrogen-free extract (NFE, i.e., starch). The metabolizable energy (ME) in the product as fed, that is, as “wet” food, is 1429.95 kcal/kg, or 4630.67 kcal/kg of dry matter. In the raw chicken recipe, the water content is 71.42%, and the dry matter 28.58%. The dry matter comprises 15.21% crude protein, 8.45% fat, 2.02% ash, 2.3% crude fiber, and 0.6% NFE (starch). The ME in the product as fed is 1271.6 kcal/kg or 4449.27 kcal/kg of dry matter. The results show that the raw frozen cat food products are high in protein and fat and extremely low in carbohydrates, a composition that closely resembles that of a natural cat diet. For example, natural prey for cats in the wild include mice and other small rodents. A mouse is [?? how much} % crude protein and 30% fat.

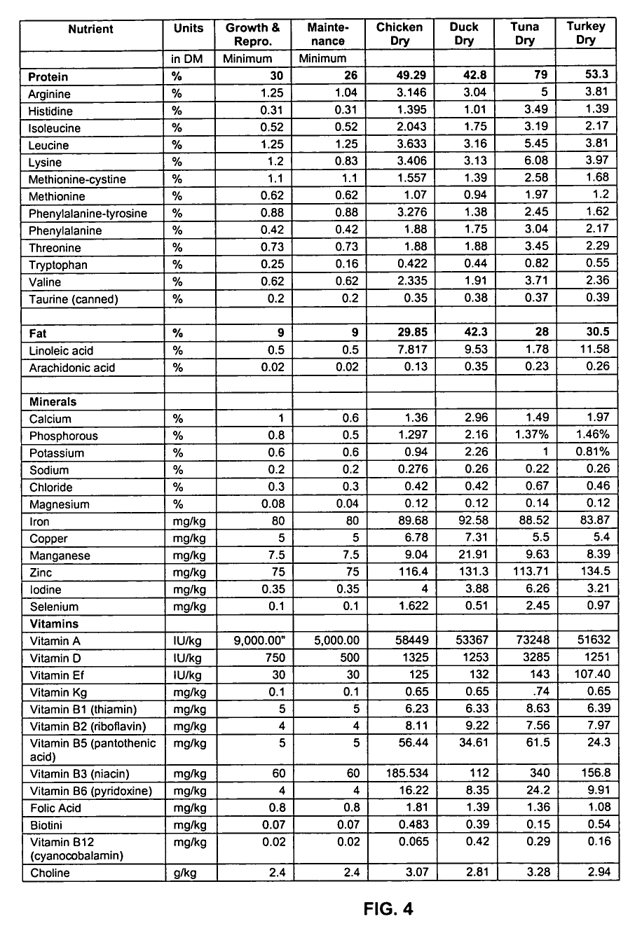

FIG. 4 is a nutrient list showing the proteins, fats, minerals, vitamins that a cat requires, and the amount (percentage or units/kg) of the nutrient found in the whole food with the water removed, that is, in the dry matter for the four recipes of the raw frozen cat food products: chicken, duck, tuna, and turkey. The columns “growth & reproduction” and “maintenance” list the AAFCO recommended daily amounts of the nutrient in dry matter for the particular life stage of the animal. The test results for the recipes are given in the columns chicken dry, duck dry, tuna dry, and turkey dry.

A careful review of the table shows that the amounts of certain nutrients in the columns chicken dry, duck dry, tuna dry, and turkey dry far exceed the recommended AAFCO amounts. AAFCO recommends a minimum of 30% protein for the growth and reproduction stage and 26% protein for the maintenance stage of a cat. These are minumum requirements. The cat is a carnivore, and, in the wild, would naturally be ingesting a much greater portion of protein food than the AAFCO recommended amounts. The recipes of the raw frozen cat food according to the invention provide protein as follows: >49% in the chicken recipe, >42% in the duck recipe, 79% in the tuna recipe, and >53% in the turkey recipe. Listed below the entry “protein” are the amino acids necessary to maintain a healthy diet for a cat. Again, a comparison of the AAFCO recommended amounts and the amounts provided in the four recipes according to the invention show that the raw frozen cat food provides amounts significantly greater than the minimum recommended amounts. The amount of taurine provided in the recipes is noted specifically here, because it is so difficult to provide sufficient amounts of taurine without adding it as a non-food supplement. The AAFCO recommended minimum daily amount for taurine in canned food is 0.2% in dry matter. The comparison is made here with canned food, because it comes closest to the raw frozen cat food according to the invention, which naturally contains 0.35% or more of taurine. By “naturally” is meant that the taurine is contained naturally in the food ingredients in the recipe. The raw frozen cat food provides at least the minimum daily amounts of all of the amino acids, fats, minerals, vitamins required to provide a healthy diet for a cat, and does so without using non-foode additives.

A further embodiment of the cat food according to the invention may contain ingredients that are cooked. As mentioned above, one of the difficulties in providing an all-natural cat food is finding foods that provide the necessary levels of taurine. Some of the ingredients used in the cat food according to the invention have such high levels of taurine, that, even if those ingredients were cooked before being added to the particular embodiment, the cat food would still provide the necessary level of taurine. So, for example, the cat food according to the invention also includes cooked mollusk.

It is understood that the embodiments described herein are merely illustrative of the present invention. Variations in the composition of the raw frozen cat food may be contemplated by one skilled in the art without limiting the intended scope of the invention herein disclosed and as defined by the following claims.

What is claimed is:

1. Pet food comprising:
a mixture of raw food ingredients and water,
wherein said mixture of raw food ingredients includes land-animal food product and mollusk food product, said mixture of raw food ingredients providing at least 0.3% taurine by weight in dry matter.

2. The pet food of claim 1, wherein said mollusk food product includes clams.

3. The pet food of claim 1, wherein said mollusk food product includes conch.

4. The pet food of claim 1, wherein said mollusk food product includes oyster.

5. The pet food of claim 1, whereins said mixture of raw food ingredients includes raw plant food ingredients.

6. The pet food of claim 5, wherein said raw plant food ingredients include rice bran.

7. The pet foold of claim 5, wherein said raw plant food ingredients include dried autolyzed yeast.

8. The pet food of claim 5, wherein said raw plant food ingredients include vegetables.

9. The pet food of claim 7, wherein said vegetables include broccoli, carrot, and spinach.

10. The pet food of claim 5, wherein said raw plant food ingredients include apple.

11. The pet food of claim 1, wherein said mixture of raw food ingredients provides at least 40% protein by weight in dry matter.

12. The pet food of claim 1, wherein said land-animal food product includes chicken muscle meat and heart.

13. The pet food of claim 1, wherein said land-animal food product includes duck flesh meat and liver.

14. The pet food of claim 1, wherein said mixture of raw food ingredients includes tuna.

15. A pet food comprising:
a mixture of natural food ingredients and water,
wherein said mixture of natural food ingredients includes land-animal food product and mollusk food product, said mixture of food ingredients providing at least 0.3% taurine by weight in dry matter.

16. A pet food comprising:
a mixture of natural food ingredients and water,
wherein said mixture of natural food ingredients includes land-animal food product and mollusk food product, said mixture of food ingredients providing at least 0.3% taurine by weight in dry matter; and
wherein said mixture of natural food ingredients does not include flour milled from grain.

17. A pet food comprising:
a mixture of natural food ingredients and water,
wherein said mixture of natural food ingredients includes land-animal food product and mollusk food product, said mixture of food ingredients providing at least 0.3% taurine by weight in dry matter; and
wherein said mixture of natural food ingredients does not include gluten.
